(19) United States
(12) Patent Application Publication
(10) Pub. No.: US 2008/0147785 A1
(43) Pub. Date: Jun. 19, 2008

(54) Medium storing web service control program, web service control apparatus, web service control method, and relay apparatus

(75) Inventor: Yuji Imai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/902,633

(22) Filed: Sep. 24, 2007

(30) Foreign Application Priority Data
Dec. 18, 2006 (JP) 2006-339447

(51) Int. Cl. G06F 15/16

(52) U.S. Cl. 709/203

(57) ABSTRACT

There is provided a medium storing a Web service control program for controlling communication between a consumer side and provider side in a Web service, a Web service control apparatus, a Web service control method, and a relay apparatus capable of controlling, based on a request reservation procedure, the amount of Web service requests to be received.

A Web service control apparatus for controlling communication between a consumer side and provider side in a Web service, comprises: a CM (Contract Manager) 21 that acquires a state of one or more servers capable of executing the Web service and a request of a Web service reservation which is a reservation to use the Web service and accepts the Web service reservation based on the state of the server and Web service reservation request; and a CK (Contract Keeper) 22 that receives a Web service request transmitted from a consumer side and transfers to the server the Web service request complying with the Web service reservation accepted by the CM 21.

### BACKGROUND OF THE INVENTION

1. Field of the Invention

The present invention relates to a medium storing a Web service control program, a Web service control apparatus, a Web service control method, and a relay apparatus that control communication between a consumer side and provider side in a Web service.

2. Description of the Related Art

In recent years, a new technical trend has emerged in an SOA (Service Oriented Architecture) that designs a system based on loosely-coupled services. In a conventional Web service system, a provider side estimates the amount of Web service requests that a consumer side will transmit and, based on its peak value, determines the total capacity of servers to be prepared.

Further, electronic negotiation technology such as WS (Web Service)—Agreement specification standardized by GGF (Global Grid Forum) has been proposed.

As a conventional art relating to the present invention, there is known a method and apparatus that manage business interaction between the parties (refer to, e.g., Patent Document 1 (PCT Laid-Open Publication No. 2006-146892)). In addition, there is known a method that provides end-to-end service quality negotiation procedure for a distributed multimedia application (refer to, e.g., Patent Document 2 (PCT Laid-Open Publication No. 2004-537187)).

However, in a conventional Web service system, an operator on the provider side estimates the Web service request amount without acquiring a clear utilization plan of each of customers on the consumer side. Further, in the case where the provider-side operator has failed in making the estimation of the Web service request amount, he or she needs to rearrange the installed capacity. Since these operations are carried out by the operator, man-hour may rise, as well as, there may be a risk of errors. Further, in the conventional Web service system, the provider-side operator conducts hearings with customers for planning addition of the installed capacity. However, in the case where the number of customers is greatly increased or the frequency of the hearings is increased, it becomes difficult for the operator to make the estimation.

Further, there may be a case where the provider side receives the number of requests exceeding the installed capacity. The provider cannot prevent such a case from occurring for technical and contractual reasons, so that servers provided on the provider side may become overloaded and even unstable.

Moreover, estimation of required resources is easy in services to scientific and engineering calculations, while the estimation is difficult in the Web service due to the existence of a case where the number of requests is increased suddenly.

### SUMMARY OF THE INVENTION

The present invention has been made to solve the above problems, and an object thereof is to provide a medium storing a Web service control program, a Web service control apparatus, a Web service control method, and a relay apparatus capable of controlling, based on a request reservation procedure, the amount of Web service requests to be received.

To solve the above problems, according to a first aspect of the present invention, there is provided a medium that stores a computer-readable Web service control program allowing a computer to execute control of communication between a consumer side and provider side in a Web service, the Web service control program allowing the computer to execute: a management step that acquires a state of one or more servers capable of executing the Web service and a request of a Web service reservation which is a reservation to use the Web service and accepts the Web service reservation based on the state of the server and Web service reservation request; and a transfer step that receives a Web service request transmitted from the consumer side and transfers to the server the Web service request complying with the Web service reservation accepted by the management step.

Further, according to a second aspect of the present invention, there is provided a Web service control apparatus for controlling communication between a consumer side and provider side in a Web service, comprising: a management section that acquires a state of one or more servers capable of executing the Web service and a request of a Web service reservation which is a reservation to use the Web service and accepts the Web service reservation based on the state of the server and Web service reservation request; and a transfer section that receives a Web service request transmitted from the consumer side and transfers to the server the Web service request complying with the Web service reservation accepted by the management section.

Further, according to a third aspect of the present invention, there is provided a Web service control method for controlling communication between a consumer side and provider side in a Web service, comprising: a management step that acquires a state of one or more servers capable of executing the Web service and a request of a Web service reservation which is a reservation to use the Web service and accepts the Web service reservation based on the state of the server and Web service reservation request; and a transfer step that receives a Web service request transmitted from the consumer side and transfers to the server the Web service request complying with the Web service reservation accepted by the management step.

Further, according to a fourth aspect of the present invention, there is provided a relay apparatus for relaying communication between a consumer side and provider side in a Web service, comprising: a request section that transmits a request of a Web service reservation which is a reservation to use the Web service to the provider side and receives a reply to the request; and a processing section that receives a Web service request issued from a terminal on the consumer side, performs processing for the Web service request based on a reply to the request of a Web service reservation which is received by the request section, and transmits the processed Web service request to the provider side.

According to the present invention, it is possible to control the amount of Web service requests to be received based on a request reservation procedure.

### BRIEF DESCRIPTION OF THE DRAWINGS

FIG. 1 is a block diagram showing an example of a configuration of a Web service system according to an embodiment of the present invention;

FIG. 2 is a sequence diagram showing an example of operation of the Web service system according to the present embodiment;

FIG. 3 is a table showing an example of the content of a price list according to the present embodiment;

FIG. 4 is a table showing a first example of a utilization plan table according to the present embodiment;

FIG. 5 is a table showing a second example of the utilization plan table according to the present embodiment;

FIG. 6 is a view showing an example of the content of a reservation request according to the present embodiment;

FIG. 7 is a view showing an example of the content of a reservation reply according to the present embodiment;

FIG. 8 is a table showing an example of the content of a provider reservation information table according to the present embodiment;

FIG. 9 is a table showing an example of the content of a server information table according to the present embodiment;

FIG. 10 is a table showing an example of the content of a consumer reservation information table according to the present embodiment; and

FIG. 11 is a table showing an example of the content of the passage determination information table according to the present embodiment.

### DETAILED DESCRIPTION OF THE PREFERRED EMBODIMENTS

An embodiment of the present invention will be described below with reference to the accompanying drawings.

A Web service in a Web service system according to the present embodiment is a service using Web Service/SOAP (Simple Object Access Protocol), REST (Representational State Transfer), HTTP (HyperText Transfer Protocol), and the like.

Further, in the present embodiment, a Web service system offering a stamp duty service will be described. In the stamp duty service, a provider side receives from a consumer side an electronic receipt issued through an electronic clearing system and appends a stamp duty (time stamp) to the electronic receipt. The consumer side that has received the service makes payment, to the provider, of a service fee charged by the provider together with the amount to be paid to the country. Hereinafter, this service is represented by a service type “TSService”, and functions offered by this service are represented by “stamp” and “check”.

First, a configuration of a Web service system according to the present embodiment will be described.

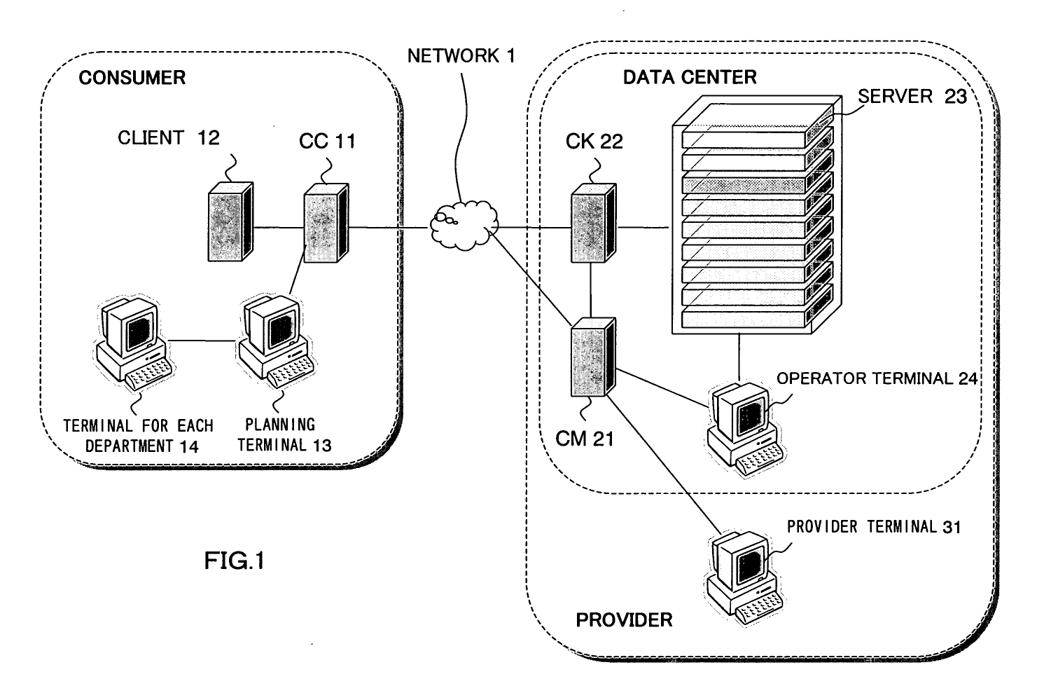

FIG. 1 is a block diagram showing an example of a configuration of a Web service system according to the present embodiment. The Web service system has, on the consumer side, a CC (Contract Client) 11 (relay apparatus), one or more clients 12, a planning terminal 13, and a terminal 14 installed in each department and has, on the provider side, a CM (Contract Manager) 21, a CK (Contract Keeper) 22, one or more server 23, an operator terminal 24, and a provider terminal 31. The CM 21, CK 22, server 23, and operator terminal 24 are installed within a data center.

The client 12 is connected to the CC 11. The CC 11 is connected to the CM 21 and CK 22 through a network 1. The CC 11 and client 12 may be incorporated in one apparatus. The planning terminal 13 is connected to the CM 21 through the network 1. The terminal 14 for each department is connected to the planning terminal 13. The CM 21 is connected to the CK 22 and server 23. The CK 22 is connected to the server 23. The operator terminal 24 is connected to the CM 21 and server 23.

The terminal 14 for each department determines service utilization plan in each department on the consumer side. The planning terminal 13 compiles the service utilization plan on the consumer side. The client 12 executes a client program to access the Web service. The operator terminal 24, which is operated by an operator on the provider side, monitors and controls the server 23. The provider terminal 31, which is operated by a person in charge on the provider side, inputs a price list and the like.

Next, operation of the Web service system according to the present embodiment will be described.

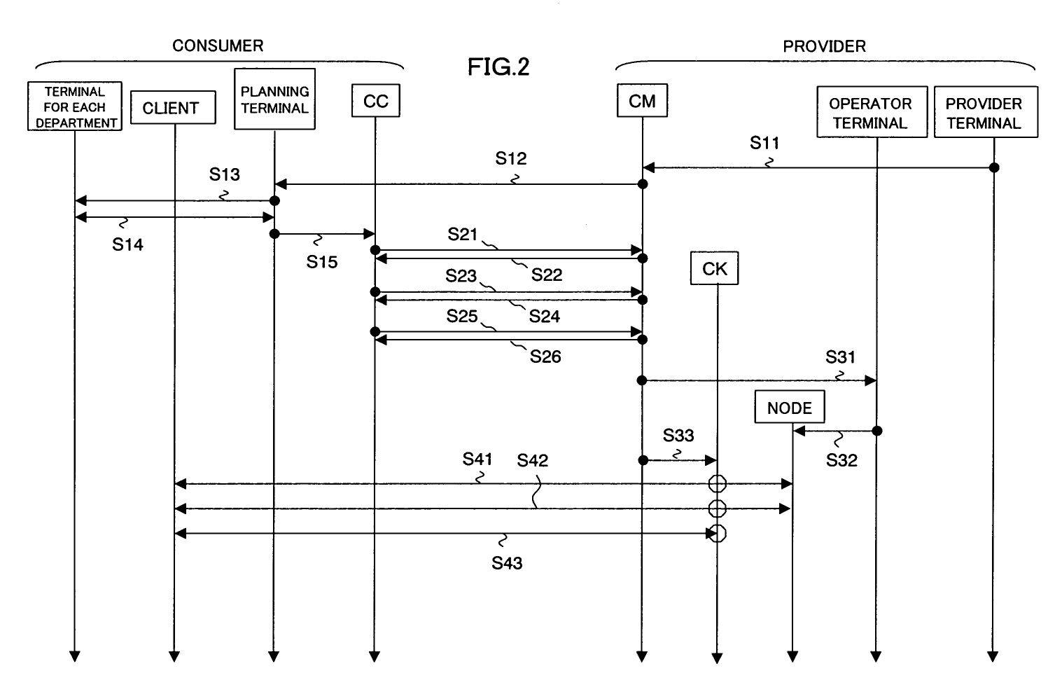

FIG. 2 is a sequence diagram showing an example of operation of the Web service system according to the present embodiment. This sequence diagram shows operations of the terminal 14 for each department, client 12, planning terminal 13, and CC 11 on the consumer side and operations of the CM 21, CK 22, node, operator terminal 24, and provider terminal 31 on the provider side. On the provider side, the node denotes one or more servers 23 allocated to a service. The Web service system performs Web service reservation processing (S11 to S31) and Web service execution processing (S32 to S43).

Next, the Web service reservation processing will be described.

The provider terminal 31 transmits a price list created by a sales representative on the provider side to the CM 21 (S11). The CM 21 transmits the received price list to the planning terminal 13 (S12). The planning terminal 13 transfers the received price list to the terminal 14 for each department (S13).

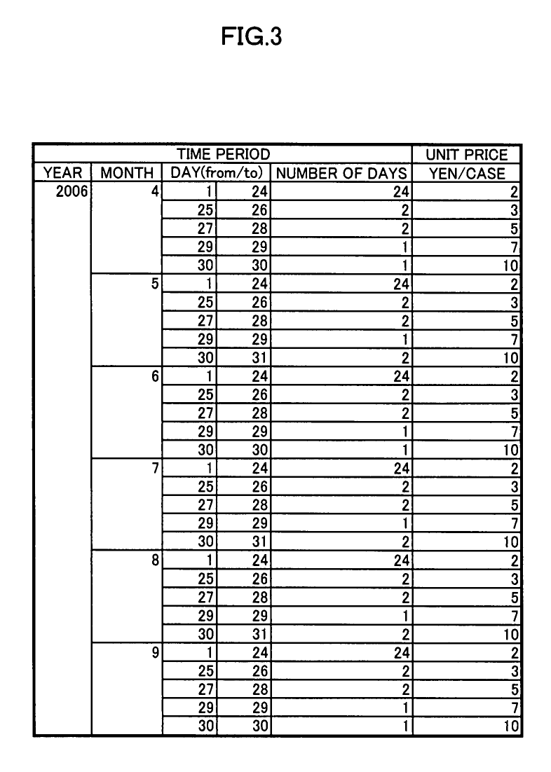

A description will be given here of the price list. FIG. 3 is a table showing an example of the content of the price list according to the present embodiment. This price list shows the price of the abovementioned “stamp” service of “TSService”. The price list shows a list of segments of service use time period and unit price of the service for each time period segment. In the “time period” item, the date (year, month and day) representing the service start day and service end day and the number of days from the service start day to service end day are recorded. Further, the time period segment is classified according to the level of the Web service request amount (for example, the time segment is classified into “off season” and “on season” groups). In the “unit price” item, price (yen/case) per one electronic receipt (one request) is recorded. Further, the list may include a maximum number of electronic receipts which represents the upper limits of the number of electronic receipts that can be reserved. The unit price may be classified into reservation time unit price representing the price to be paid at the reservation time and execution time price unit representing the price to be paid at the execution time.

Then, a person in charge of each department designs service utilization plan of his or her own department based on the received price list and past performance table and the terminal 14 for each department notifies the planning terminal 13 of the service utilization plan (S14).

The planning terminal 13 then compiles the utilization plans from respective departments to thereby create a utilization plan table and transmits the table to the CC 11 (S15).

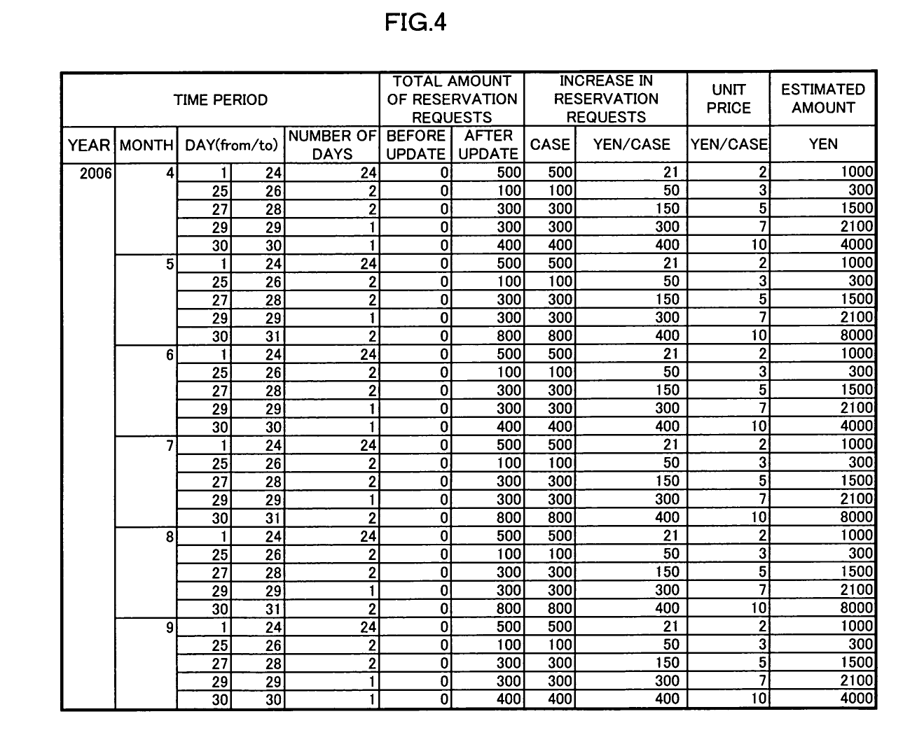

A description will be given here of the utilization plan table. FIG. 4 is a table showing a first example of the utilization plan table according to the present embodiment. This utilization plan table shows a list of segments of service use time period, as well as, total amount of reservation requests, increase in reservation requests, unit price, and estimated amount for each time period segment.

In the “time period” item, the same values as those in the price list are recorded. The “total amount of reservation requests” item represents the total number of Web service requests to be reserved, and “increase in reservation requests” item represents the number of Web service requests to be newly reserved. In the “total amount of reservation requests” item, the total amount of reservation requests before update [case] representing the total amount of requests in a past utilization plan table and total amount of reservation requests after update [case] representing the total amount of requests up to this time are recorded. In the “increase in reservation requests” item, increase in the amount of reservation requests [case] and increase in the amount of reservation requests per one day [case/day] are recorded. In the “unit price” item, the same values as those in the price list are recorded. In the “estimated amount” item, increase in the charge to be paid for the service (increase in reservation requests×unit price) is recorded. The utilization plan table of FIG. 4 is a utilization plan table that has been created first. Therefore, all values for the total amount of reservation requests before update are 0, and the total amount of reservation requests after update and increase in reservation requests are equal to each other.

The planning terminal 13 can update the utilization plan table even after transmitting the utilization plan table to the CC 11 and transmit the latest utilization plan in the form of a difference from the immediately preceding utilization plan table. FIG. 5 is a table showing a second example of the utilization plan table according to the present embodiment. The utilization plan table of FIG. 5 is one that has been created after the utilization plan table of FIG. 4. Therefore, the total amount of reservation requests before update of FIG. 5 corresponds to the total amount of reservation requests after update of FIG. 4, and the total amount of reservation requests after update of FIG. 5 is a value obtained by adding the increase in the number of reservation requests to the total amount of reservation requests before update.

The CC 11 then starts electronic negotiation with the CM 21 for service reservation (S21). The CM 21 prepares authentication processing and the like according to a specification of the electronic negotiation (S22). The CC 11 transmits a reservation request to the CM 21 (S23, S25). Upon receiving the reservation request, the CM 21 performs reservation determination processing to make determination whether it accepts or rejects the reservation request based on a reservation condition and received reservation request and reservation reply processing to transmit a reservation reply to the CC 11 in accordance with a result of the determination (S24, S26).

Each of the reservation request and reservation reply is a machine-readable agreement conforming to Agreement document format defined in a specification (e.g., GGF WS-Agreement specification) of the electronic negotiation and is described in XML (Extensible Markup Language) or the like. When a reservation reply indicating “acceptance” is transmitted from the CM 21 to CC 11, the relevant agreement is completed. In this agreement, the provider side shows to the consumer side that it can reject the Web service request different from the reserved request condition.

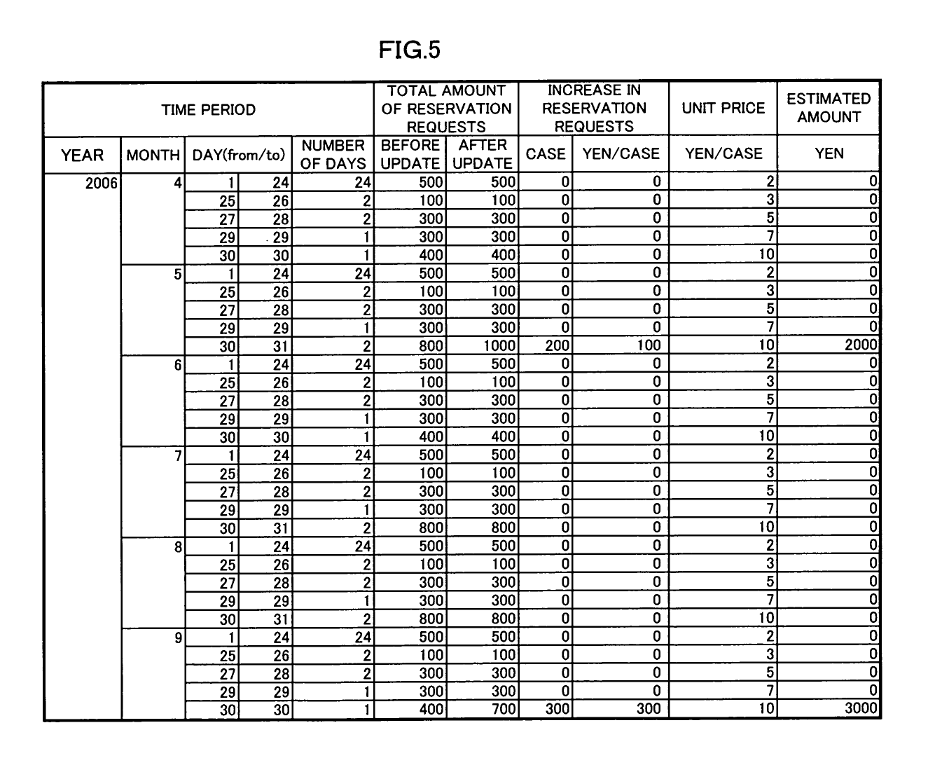

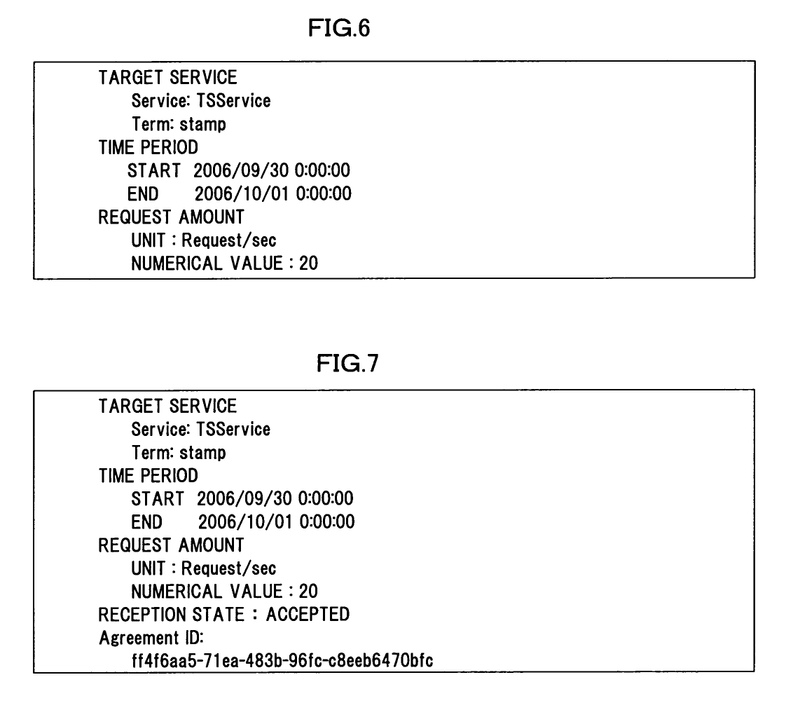

A description will be given here of the content of the reservation request. FIG. 6 is a view showing an example of the content of the reservation request according to the present embodiment. The reservation request describes “target service”, “reservation time period”, and “request amount”. The “target service” is represented by service type (service) and function (term). In this example, the service type is TSService, and function is stamp. The “reservation time period” is represented by start time and end time. The “request amount”, which is a Web service request amount (processing amount), is represented by unit and numerical value. In this example, the unit is RPS (Request/sec), and numerical value is 20.

A description will next be given of the content of the reservation reply. FIG. 7 is a view showing an example of the content of the reservation reply according to the present embodiment. The reservation reply describes “target service”, “reservation time period”, “request amount”, and “reception state”. Each of the “target service”, “reservation time period”, and “request amount” has the same value as that of the corresponding reservation request. The “reception state” assumes two values of “accepted” indicating that a reservation request has been accepted and “rejected” indicating that a reservation request has been rejected depending on the result of the reservation determination processing. In the case where a reservation request has been accepted, a reservation described in the reservation request is made and thereby agreement is completed. Then, an agreement ID is given to the agreement by the CM 21 and is described in the reservation reply. In this example, the “reception state” is “accepted” and thus the agreement ID has been described.

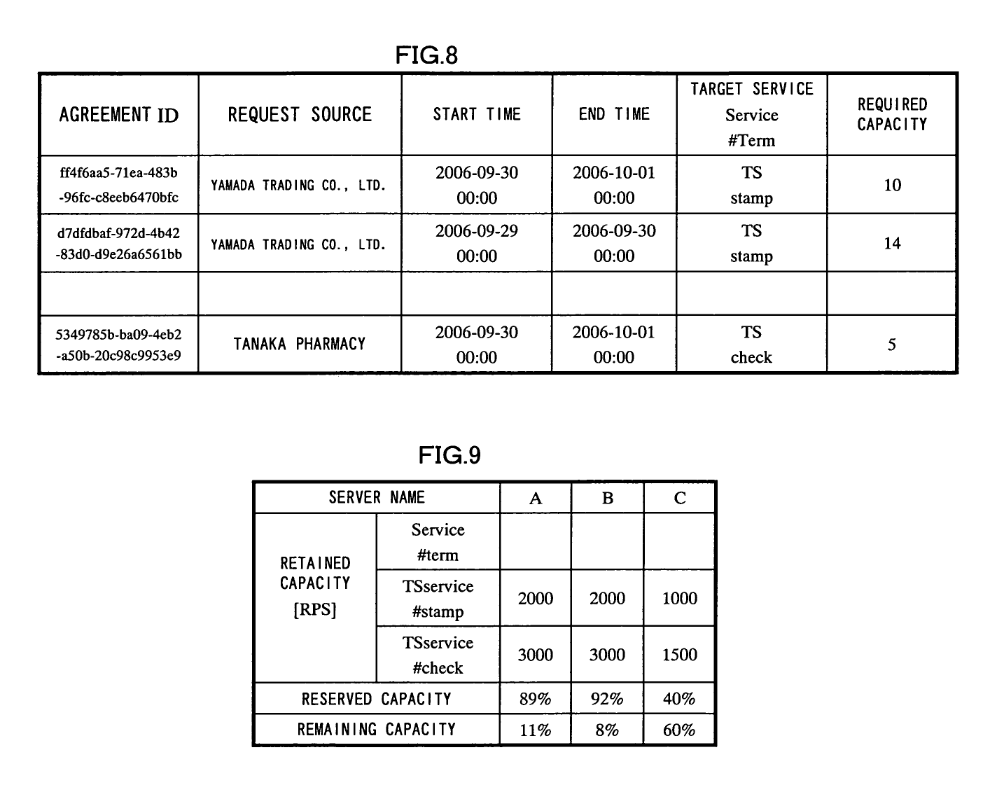

The CM 21 retains a provider reservation information table and, when the reservation is established, registers information of the established reservation in the provider reservation information table. FIG. 8 is a table showing an example of the content of the provider reservation information table according to the present embodiment. The provider reservation information table has provider reservation information which is information relevant to each established reservation. The provider reservation information has items of “agreement ID”, “request source”, “start time”, “end time”, “target service”, “required capacity”. The “agreement ID” has the same value as that of the “agreement ID” in the reservation reply. The “reply source” is the name of the consumer side. The reservation time period (“start time” and “end time”) and “target service” have the same value as those described in the accepted reservation request. The “required capacity” has the same value as that of the “request amount” described in the accepted reservation request and represents the processing capacity required for executing a reserved service.

The CM 21 sets the reservation time period described in the received reservation request as a coverage time period and, based on the coverage time period and provider reservation information table, creates a server information table. FIG. 9 is a table showing an example of the content of the server information table according to the present embodiment. The server information table shows server information relevant to each server 23. The server information represents a state of the server 23 in the coverage time period and has items of “retained capacity [RPS]”, “reserved capacity [%]”, and “remaining capacity [%]”. The “retained capacity” is a value representing the maximum value of the processing capacity of the server by the amount of Web service requests on a per-service basis. In this example, stamp of TSService and check of TSService are set as the target service. The “reserved capacity” is a value representing the total sum of the processing capacities that have been reserved in the coverage time period as a ratio [%] relative to the retained capacity. The “remaining capacity”, which is obtained by (100%−reserved capacity), represents the processing capacity that has not been reserved as a ratio [%] relative to the retained capacity.

The CM 21 then determines whether the content of the reservation request satisfies the reservation condition. In the case where the reservation condition is satisfied, the CM 21 registers the content of the reservation request as the provider reservation information and sends back a reservation reply indicating “accepted” to the client 12. On the other hand, in the case where the reservation condition is not satisfied, the CM 21 sends back a reservation reply indicating “rejected” to the client 12. The reservation condition specifies that the request amount in the reservation request be not more than the remaining capacity in the server information table. That is, in the case where the request amount of the received reservation request exceeds the remaining capacity, the CM 21 sends back the reservation reply indicating “rejected”.

Alternatively, in the case where reservation preparation time period is set and where the CM 21 sets a value obtained by (start time of reservation time period in reservation request−reservation preparation time period) as reservation deadline of the reservation request, the reservation condition may specify that the current time falls within the reservation deadline of the reservation request. That is, in the case where the current time at the time point when receiving the reservation request passes the reservation deadline set for the reservation request, the CM 21 sends back a reservation reply indicating “rejected”.

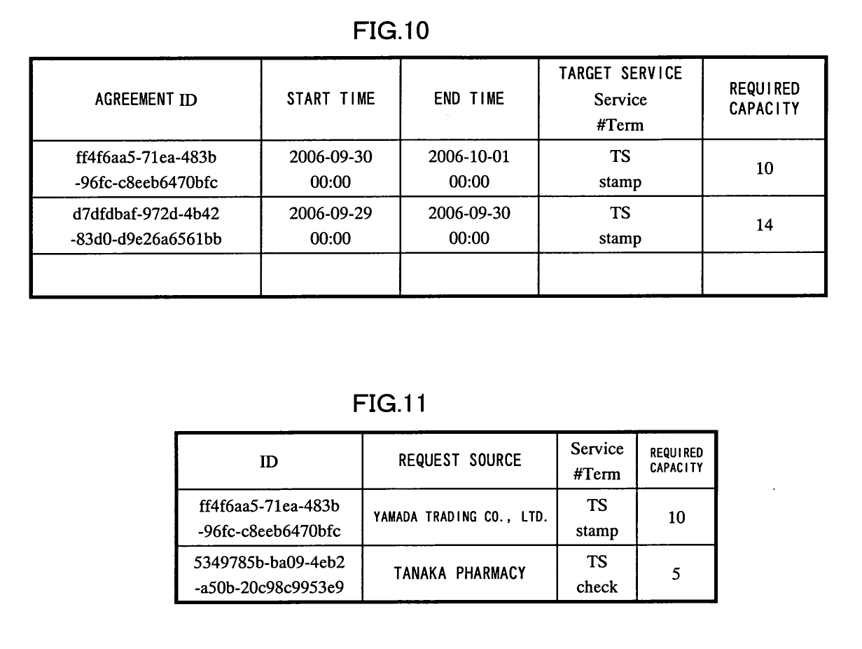

The CC 11 retains a consumer reservation information table and, when receiving a reservation reply indicating “accepted”, registers the content included in the reservation reply in the consumer reservation information table. FIG. 10 is a table showing an example of the content of the consumer reservation information table according to the present embodiment. The consumer reservation information table has consumer reservation information which is information relevant to each reservation reply indicating “accepted”. The consumer reservation information has items of “agreement ID”, reservation time period (“start time” and “end time”), “target service”, and “required capacity” which have the same values as those of the provider reservation information.

The CM 21 then transmits the provider reservation information to the operator terminal 24 (S31). The operator refers to the provider reservation information displayed on the operator terminal 24 to determine allocation of the nodes.

Next, the Web service execution processing will be described.

According to given provider reservation information that has been received from the CM 21, the operator terminal 24 allocates, as nodes, the number of the servers 23 that can assure the required capacity corresponding to the relevant provider reservation information by the start time of the reservation time period thereof (S32). Further, in the case where the reservation time period of the relevant provider reservation information has ended, the operator terminal 24 releases the number of nodes corresponding to the required capacity of the relevant provider reservation information.

Then, at the start time of the reservation time of the relevant provider reservation information, the CM 21 transmits the relevant provider reservation information to the CK 22, and the CK 22 registers the content of the received provider reservation information in a passage determination information table (S33). In the case where the current time has passed the end time of the reservation time period described in passage determination information, the CM 21 deletes the passage determination information from the passage determination information table.

A description will be given here of the passage determination information table. FIG. 11 is a table showing an example of the content of the passage determination information table according to the present embodiment. The passage determination information table has passage determination information relevant to each received provider reservation information. The passage determination information is information for the CK 22 to determine the Web service request and has items of “agreement ID”, “request source”, “target service”, and “required capacity”, which have the same values as those of the provider reservation information. Further, the passage determination information table has only passage determination information whose reservation time period includes the current time.

Then, the client 12 uses a client program of the Web service to transmit a Web service request to a node through the CC 11 and CK 22. In the case where the Web service request received from the client 12 satisfies an added condition, the CC 11 acquires the corresponding agreement ID from the client reservation information table and adds the agreement ID to the Web service request. Here, the added condition specifies that client reservation information in which the target service is the same as that specified in the Web service request and in which the reservation time period includes the current time exist in the client reservation information table.

The CK 22 receives the Web service request from the CC 11 and compares the Web service request with passage determination information table. In the case where the Web service request satisfies the passage condition, the CK 22 transfers the Web service request to the node (S41, S42). In the case where the Web service request does not satisfy the passage condition, the CK 22 does not transfer the Web service request to the node but transmits a notification representing “rejected” to the client 12 (S43). Here, the passage condition specifies that the passage determination information whose agreement ID is the same as the agreement ID of the received Web service request exist in the passage determination information table, and that the Web service request amount corresponding to the agreement ID be not more than the required capacity in the passage determination information.

Note that not only a single passage condition, but also a plurality of passage conditions may be set. In this case, different unit prices may be set for a plurality of passage conditions.

The node executes the service according to the Web service request received from the CK 22 and transmits a result of the execution to the client 12. The CK 22 transmits the information of the Web service request that the CK 22 allows to pass therethrough to the CM 21. The CM 21 tallies the information of the Web request service for each request source, each target service, and each time period segment and records it as an achievement information table. This achievement information table is used when the provider side charges the consumer side for a service fee.

According to the present embodiment, the CK 22 can reject a Web service request that does not satisfy a reserved condition. Further, by enabling the rejection of unfavorable Web service request, it is possible to prevent overload on the node, thereby enhancing stability of the system. Further, a reservation process concerning the Web service request amount can be automatically performed. Therefore, man-hour can significantly be reduced, making it possible to cope with a large number of consumers or frequent updates of reservation concerning the Web service request amount. Further, by setting the reservation preparation time period, it is possible to take some measures before the start of the reservation time period such as enhancement of facility.

Comparing with a Web service system using an autonomous system, the Web service system according to the present embodiment is easier to control and, further, facility arrangement and cost calculation are also easier.

The CC 11, CM 21, and CK 22 according to the abovementioned embodiment can easily be applied to an information communication apparatus to thereby increase performance thereof. Examples of the information communication apparatus include a server, a router, a switch, and the like.

Further, it is possible to provide a program that allows a computer constituting the Web service system to execute the above steps as a Web service control program. By storing the above program in a computer-readable storage medium, it is possible to allow the computer constituting the Web service system to execute the program. The computer-readable storage medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

A management section corresponds to the CM 21 in the embodiment. A transfer section corresponds to the CK 22 in the embodiment. A request section and processing section correspond to the CC 11 in the embodiment. A management step corresponds to steps S21 to S26 in the embodiment. A transfer step corresponds to the processing performed by the CK 22 in steps S41 to S43 in the embodiment. A processing step corresponds to the processing performed by the CC 11 in steps S41 to S43 in the embodiment.

What is claimed is:

1. A medium that stores a computer-readable Web service control program allowing a computer to execute control of communication between a consumer side and provider side in a Web service, the Web service control program allowing the computer to execute:
a management step that acquires a state of one or more servers capable of executing the Web service and a request of a Web service reservation which is a reservation to use the Web service and accepts the Web service reservation based on the state of the server and Web service reservation request; and
a transfer step that receives a Web service request transmitted from the consumer side and transfers to the server the Web service request complying with the Web service reservation accepted by the management step.

2. The medium storing a Web service control program according to claim 1, wherein
the management step receives the Web service reservation request according to an electronic negotiation process and transmits a reply indicating acceptance or rejection of the Web service reservation according to an electronic negotiation process.

3. The medium storing a Web service control program according to claim 2, wherein
the management step sets a reservation identifier for the accepted Web service reservation and includes the reservation identifier in a reply indicating acceptance of the Web service request.

4. The medium storing a Web service control program according to claim 3, wherein
in the case where a received Web service request includes the reservation identifier, the transfer step determines that the received Web service request complies with a Web service reservation corresponding to the reservation identifier.

5. The medium storing a Web service control program according to claim 1, wherein
the Web service reservation includes a condition specifying a time period during which the Web service request to be transmitted from the consumer side to provider side is made and a condition specifying a processing amount for the Web service.

6. The medium storing a Web service control program according to claim 5, wherein
in the case where a received Web service request includes the reservation identifier and satisfies the conditions specifying a time period and processing amount which are included in a corresponding Web service reservation, the transfer step determines that the received Web service request complies with the Web service reservation.

7. The medium storing a Web service control program according to claim 1, wherein
the Web service control program further allows a computer to execute:
a processing step that receives a Web service request issued from a terminal on the consumer side, performs processing for the Web service request based on a Web service reservation accepted by the management step, and transmits the processed Web service request to the transfer step.

8. The medium storing a Web service control program according to claim 7, wherein
in the case where the received Web service request complies with the content of the Web service reservation accepted by the management step, the processing step adds the reservation identifier of the Web service reservation to the received Web service request.

9. The medium storing a Web service control program according to claim 1, wherein
the state of the server includes the processing capacity of the server, and
when determining the processing capacity can execute the Web service reservation, the management step accepts the Web service reservation.

10. The medium storing a Web service control program according to claim 9, wherein
in the case where the processing capacity that has not been reserved in the time period of the Web service reservation is not less than that specified in the Web service reservation, the management step determines that the Web service reservation can be executed.

11. The medium storing a Web service control program according to claim 5, wherein
the processing amount is the number of Web service requests per a unit time.

12. The medium storing a Web service control program according to claim 1, wherein
the Web service is a service using at least one of SOAP, REST, and HTTP.

13. A Web service control apparatus for controlling communication between a consumer side and provider side in a Web service, comprising:
a management section that acquires a state of one or more servers capable of executing the Web service and a request of a Web service reservation which is a reservation to use the Web service and accepts the Web service reservation based on the state of the server and Web service reservation request; and
a transfer section that receives a Web service request transmitted from the consumer side and transfers to the server the Web service request complying with the Web service reservation accepted by the management section.

14. The Web service control apparatus according to claim 13, wherein
the management section receives the Web service reservation request according to an electronic negotiation process and transmits a reply indicating acceptance or rejection of the Web service reservation according to an electronic negotiation process.

15. The Web service control apparatus according to claim 14, wherein
the management section sets a reservation identifier for the accepted Web service reservation and includes the reservation identifier in a reply indicating acceptance of the Web service request.

16. The Web service control apparatus according to claim 15, wherein
in the case where a received Web service request includes the reservation identifier, the transfer section determines that the received Web service request complies with a Web service reservation corresponding to the reservation identifier.

17. A Web service control method for controlling communication between a consumer side and provider side in a Web service, comprising:
a management step that acquires a state of one or more servers capable of executing the Web service and a request of a Web service reservation which is a reservation to use the Web service and accepts the Web service reservation based on the state of the server and Web service reservation request; and
a transfer step that receives a Web service request transmitted from the consumer side and transfers to the server the Web service request complying with the Web service reservation accepted by the management step.

18. The Web service control method according to claim 17, further comprising after the management step:
a processing step that receives a Web service request issued from a terminal on the consumer side, performs processing for the Web service request based on a Web service reservation accepted by the management step, and transmits the processed Web service request to the transfer step.

19. A relay apparatus for relaying communication between a consumer side and provider side in a Web service, comprising:
a request section that transmits a request of a Web service reservation which is a reservation to use the Web service to the provider side and receives a reply to the request; and
a processing section that receives a Web service request issued from a terminal on the consumer side, performs processing for the Web service request based on a reply to the request of a Web service reservation which is received by the request section, and transmits the processed Web service request to the provider side.

20. The relay apparatus according to claim 19, wherein
in the case where the request of the Web service reservation is accepted by the provider side, the reply to the request includes a reservation identifier set for the Web service reservation, and
in the case where the received Web service request complies with the content of the Web service reservation accepted by the provider side, the processing section adds the reservation identifier of the Web service reservation to the received Web service request.
